(19) United States
(12) Patent Application Publication
(10) Pub. No.: US 2015/0328911 A1
(43) Pub. Date: Nov. 19, 2015

(54) PRINTHEAD ASSEMBLY

(71) Applicant: HEWLETT-PACKARD DEVELOPMENT COMPANY, L.P., Houston, TX (US)

(72) Inventors: Jesus Garcia Maza, Terrassa (ES); David Claramunt Morera, Sant Esteve Sesrovires (BCN) (ES); Ignacio Picatoste Olloqui, Barcelona (ES)

(21) Appl. No.: 14/759,632

(22) PCT Filed: Jan. 9, 2013
(86) PCT No.: PCT/US2013/020825

§ 371 Date: Jul. 7, 2015

(51) Int. Cl. B41J 25/34

(52) U.S. Cl. CPC B41J 25/34

(57) ABSTRACT

In one example, a printhead assembly for dispensing liquid on to a substrate includes a first printhead to dispense a first liquid and a second printhead to dispense a second liquid different from the first liquid. The position of the first printhead is not adjustable along a line of substrate advance and the position of the second printhead is adjustable along the line of substrate advance.

### BACKGROUND

In scanning type inkjet printers, ink is dispensed from printheads carried on a movable carriage that is scanned back and forth across the paper or other print substrate during printing operations. The size of the carriage in larger inkjet printers that use many printheads is an important factor that can significantly affect both the performance and the size of the printer.

### DRAWINGS

FIG. 1 illustrates an inkjet printer implementing one example of a new printhead carriage assembly in which a single printhead that is adjustable along a line of substrate advance is used with multiple printheads that are fixed (not adjustable) along the line of substrate advance.

FIGS. 2-4 show the carriage assembly from the printer of FIG. 1 in more detail.

FIG. 5 is a close-up section view of the adjustable position printhead from the carriage assembly shown in FIGS. 1-4 taken along the line 5-5 in FIG. 4.

FIG. 6 illustrates another example of a new printhead carriage assembly in which the position of the adjustable printhead extends upstream and downstream of the fixed position printheads.

FIG. 7 illustrates another example of a new printhead carriage assembly in which a fixed position printhead and an adjustable position printhead flank a group of fixed position printheads.

FIG. 8 illustrates another example of a new printhead carriage assembly in which a pair of adjustable position printheads flank a group of fixed position printheads.

FIG. 9 illustrates another example of a new printhead carriage assembly in which an adjustable position printhead is used with a single fixed position printhead.

The same part numbers designate the same or similar parts throughout the figures.

### DESCRIPTION

It is desirable for some printing applications to print with more than just the conventional cyan (C), magenta (M), and yellow (Y) inks. For example, it is increasingly common to also print with white ink, and/or to use printheads to apply pre-printing and post-printing treatment solutions to the print substrate. Adding printheads to the carriage for these or other functions, however, can affect the overall size of the printer as well as some of the printing parameters. This is especially relevant for printing with white ink and for applying substrate pre-treatments and post-treatments, where the ink/treatment may be applied before and/or after printing CMY inks. In a conventional carriage assembly, if the printer is to have the desired versatility to print with white ink and/or apply pre-treatments and post-treatments, the carriage will need to include a dedicated space for individual printheads for the added color and treatment functions. For many printers, it is difficult or even impractical to make the carriage big enough to include such added functionality.

A new printhead assembly has been developed to help optimize the layout of printheads on a movable, scanning type carriage, keeping the carriage as small as possible while still maintaining the desired performance. In one example, the new printhead assembly includes one or more printheads whose position is adjustable along the line of substrate advance, as well as printheads whose position is fixed along the line of substrate advance. For example, the fixed position printheads are used to print with CMY inks and an adjustable position printhead is used to print with white ink. The white ink printhead may be positioned upstream from the CMY ink printheads when it is desired to apply white ink on the substrate before applying CMY inks, and the white ink printhead may be positioned downstream from the CMY ink printheads when it is desired to apply white ink after applying CMY inks. Of course, other configurations and functions are possible. The use of adjustable position printheads enables more printhead configurations for more versatile printer functions with fewer printheads.

Examples of a new printhead assembly are described below with reference to a scanning type inkjet printer with a movable carriage. The new assembly, however, is not limited to scanning type inkjet printers, movable carriages or even inkjet printing, but may be implemented in other types of printers or in other inkjet type liquid dispensers. Accordingly, the examples shown in the figures and described herein illustrate but do not limit the invention, which is defined in the Claims following this Description.

A “printhead” as used in this document refers to that part of an inkjet printer or other inkjet type dispenser that dispenses liquid from one or more openings, for example as drops or streams, and is not limited to printing with ink but also includes inkjet type dispensing of other liquids and/or for uses other than printing.

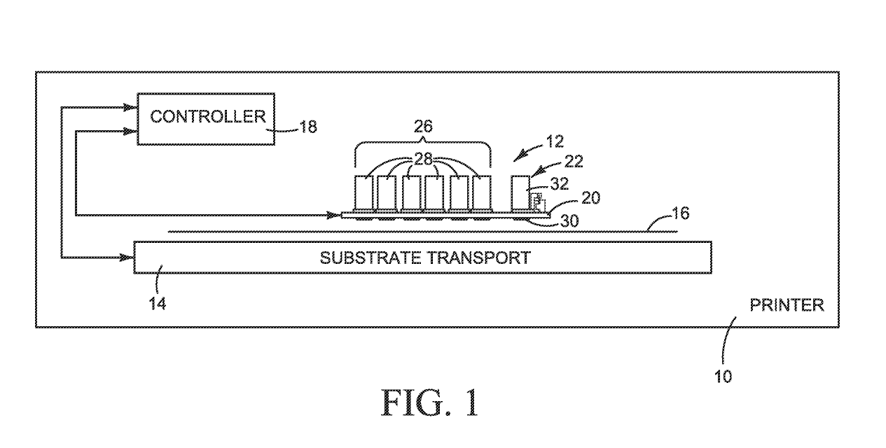

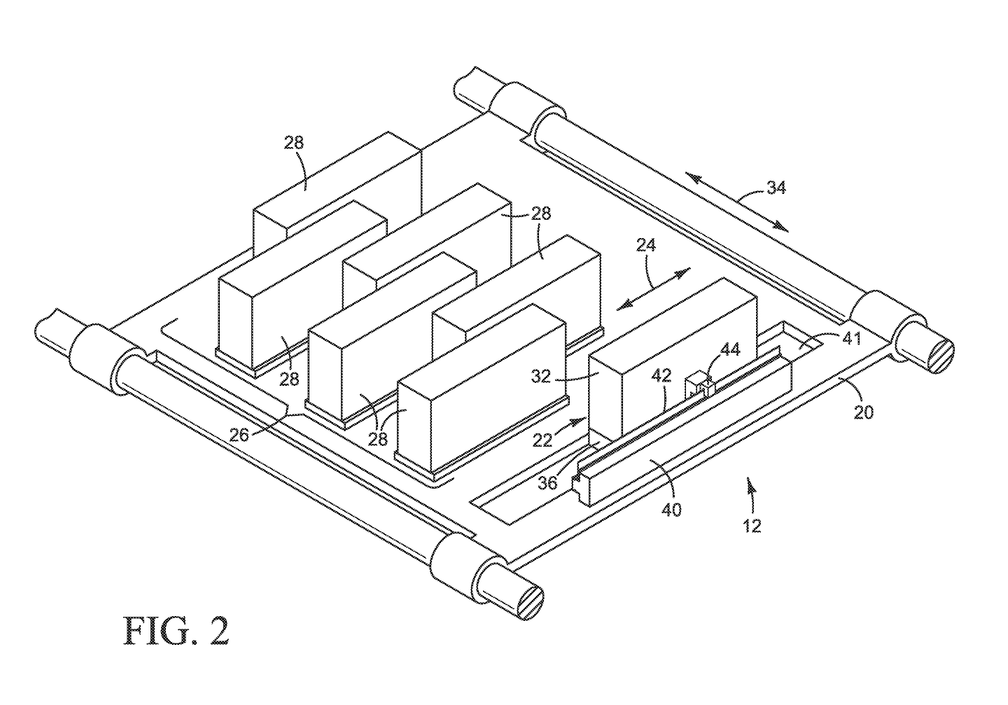

FIG. 1 illustrates an inkjet printer 10 implementing one example of a new printhead carriage assembly 12. FIGS. 2-4 show carriage assembly 12 in more detail. Referring first to FIG. 1, printer 10 includes carriage assembly 12, a print substrate transport system 14 for moving a print substrate 16 past carriage assembly 12, and a printer controller 18. Controller 18 represents generally the programming, processor(s) and associated memories, and the electronic circuitry and components needed to control the operative elements of printer 10.

Referring now also to FIGS. 2-4, carriage assembly 12 includes a chassis 20 supporting a single printhead 22 adjustable back and forth along the line of substrate advance 24 and a group 26 of multiple printheads 28 that are fixed (not adjustable) along line 24. (The line of substrate advance 24 is perpendicular to the face of the page in FIG. 1 and, therefore, line 24 is not called out in FIG. 1.) Each printhead 22, 28 is depicted as an integrated assembly that includes a printhead 30 exposed below chassis 20 for dispensing ink or other liquid on to substrate 16 and a pressure regulator unit and/or liquid reservoir 32 that supplies ink or liquid to the printhead 30.

Although it is expected that printheads 22 and 28 will usually be configured as an assembly such as that shown in the figures, commonly referred to as a pen or cartridge, other suitable configurations for printheads 22 and 28 are possible. Also, while the position of printheads 22, 28 usually will be fixed (not adjustable) along the line 34 carriage 12 is scanned back and forth across substrate 16 (usually perpendicular to substrate advance line 24), it may be desirable in some printing applications to make one or more of the printheads 22, 28 adjustable along carriage scan line 34.

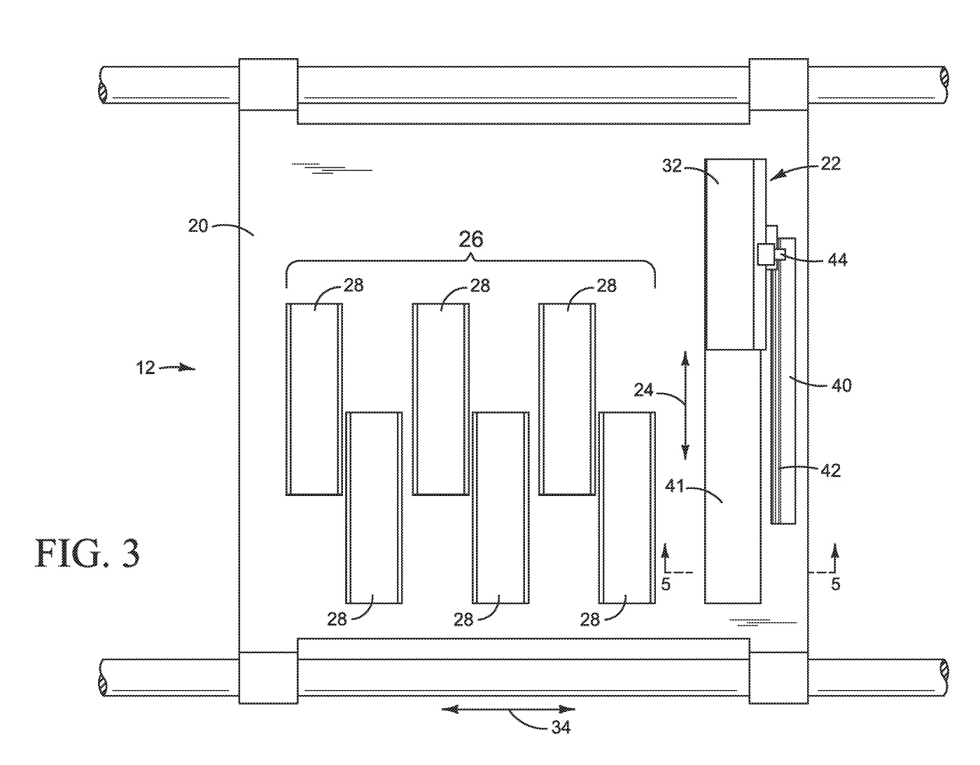

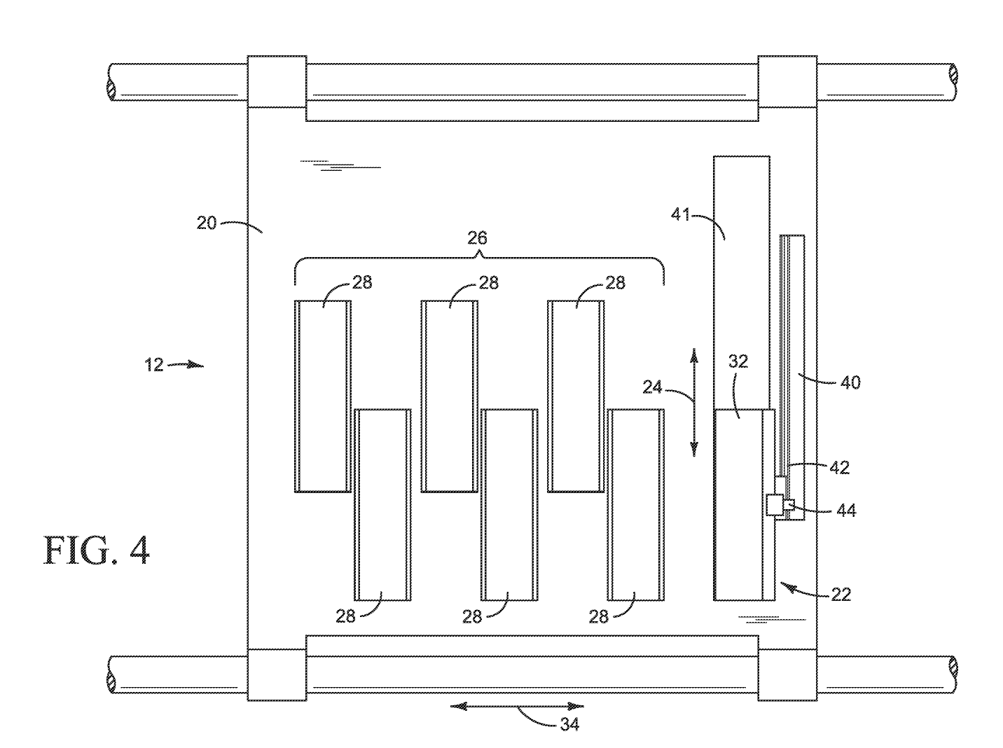

In the example shown in FIGS. 2-4, adjustable position printhead 22 is located along one side of fixed position printhead group 26 with a range of adjustment that extends from upstream of group 26 along the line of substrate advance 24 to the downstream end of group 26. In this configuration, printhead 22 may be positioned upstream from group 26, as shown in FIG. 3, to dispense ink or other liquid before printheads 28 or printhead 22 may be aligned with printheads 28, as shown in FIG. 4, to dispense liquid with printheads 28. For example, a white printhead 22 positioned upstream of color printheads 28 may be used to apply a white base, for instance on a non-white substrate, and a white printhead 22 aligned with color printheads 28 may be used to sandwich a white layer between color layers, for instance for window graphics seen from both sides.

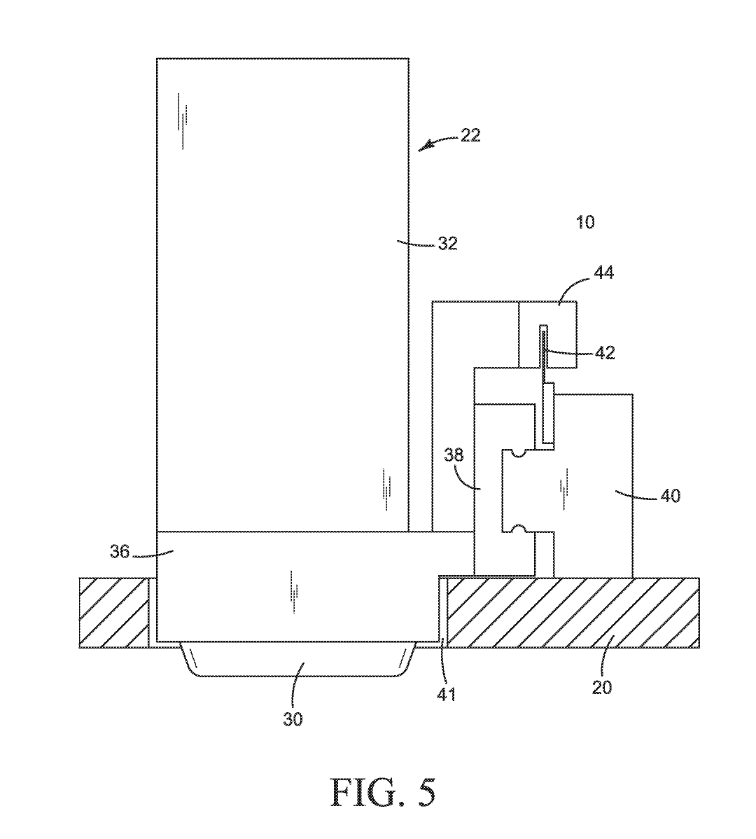

Referring now also to the close-up view of FIG. 5, adjustable position printhead 22 is supported on and moves along chassis 20 through a base 36, a follower 38, and a guide rail 40 affixed to chassis 20. Printhead 22 is mounted to base 36 which is movable in a slot 41 in chassis 20. Follower 38 is attached to or integral with base 36 and slides along guide rail 40. In the example shown, rail 40 defines an uninterrupted guide path that enables adjusting the position of printhead 22 along a continuum of possible positions. Follower 38 may be moved along guide 40 manually, or automatically using a reversible stepper motor and a linear actuator (not shown) or other suitable drive mechanism. Also, the position of follower 38 along guide 40 and thus the position of printhead 22 may be determined (and controlled for automatic adjustment), for example, using an encoder strip 42 and reader 44 coupled to printer controller 18 or to a local motor controller.

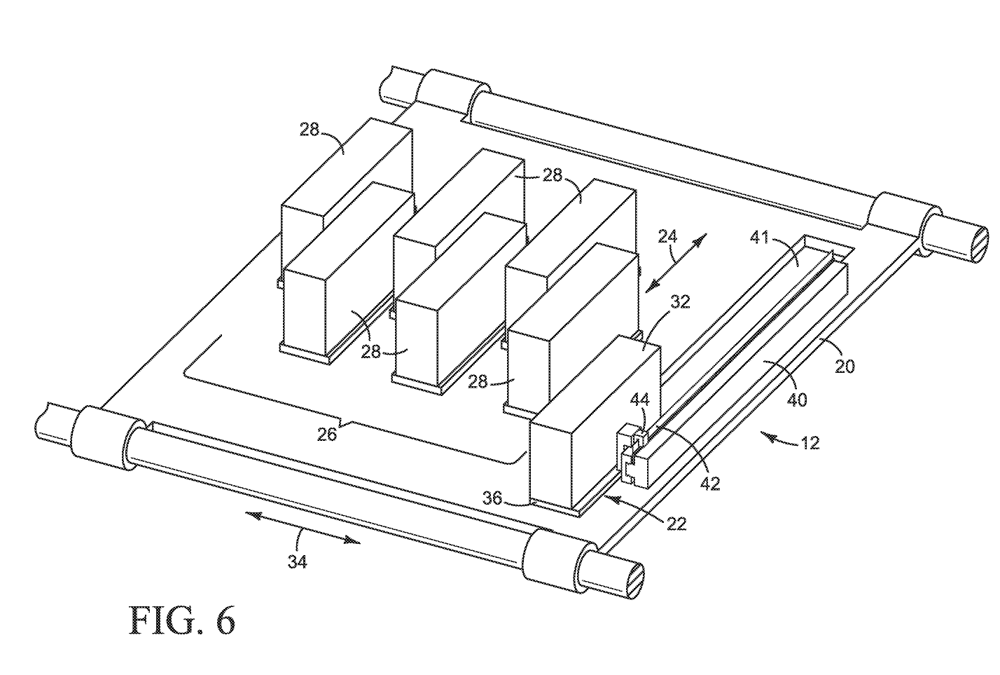

In the example shown in FIG. 6, the range of travel of adjustable position printhead 22 is extended to downstream of the group 26 of fixed position printheads 28. In this configuration, printhead 22 may be positioned upstream from printheads 28 to dispense white ink, treatment solution or another liquid before printheads 28, aligned with printheads 28 to dispense the liquid with printheads 28, or downstream from printheads 28 to dispense the liquid after printheads 28. In this example, adjustable position printhead 22 has the added capability to print white ink (or a post-printing treatment) over colors applied with printheads 28, such as might be desired for transparent or translucent substrates.

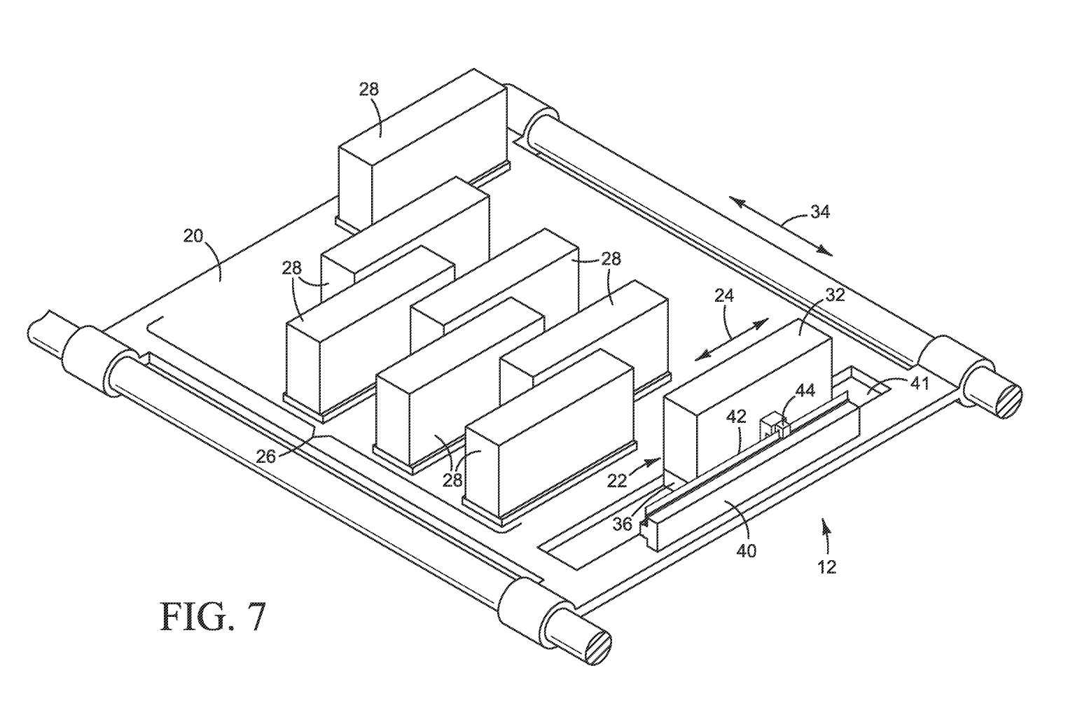

In the example shown in FIG. 7, an adjustable position printhead 22 is used with a fixed position printhead 46 located outboard and upstream from printhead group 26 opposite printhead 22.

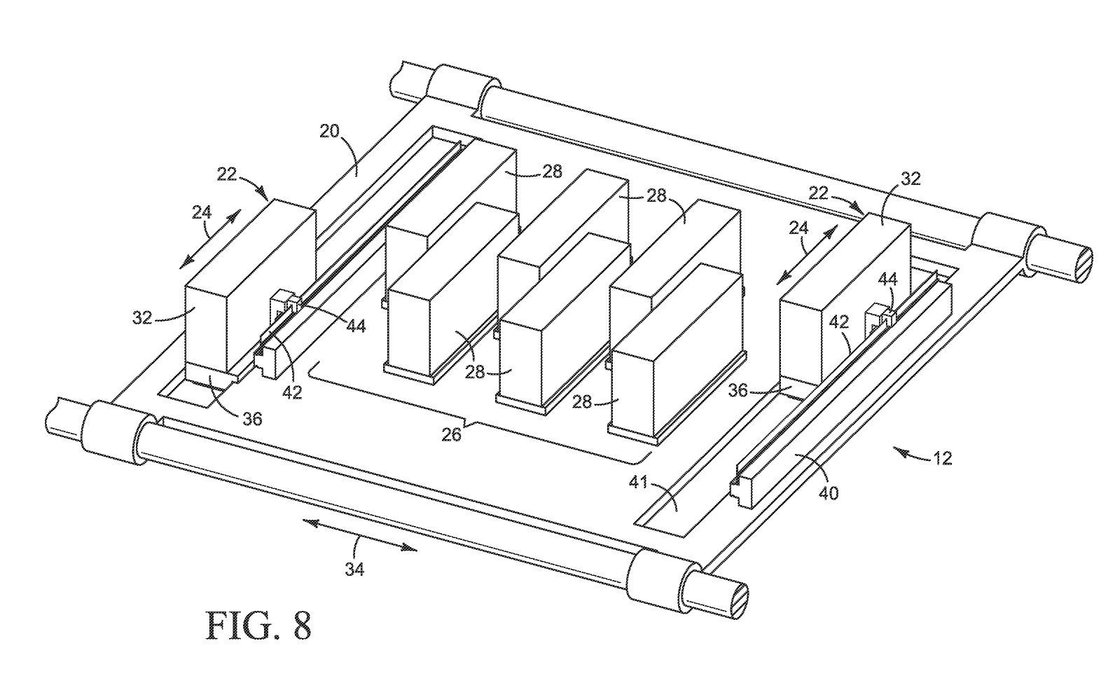

In the example shown in FIG. 8, an adjustable position printhead 22 is located on each side of printhead group 26 and the range of travel of both printheads 22 extends from upstream of group 26 to downstream of group 26. Accordingly, in this configuration, each adjustable position printhead 22 flanking group 26 may be positioned upstream from printheads 28 to dispense white ink, treatment solution or another liquid before printheads 28, aligned with printheads 28 to dispense the liquid with printheads 28, or downstream from printheads 28 to dispense the liquid after printheads 28.

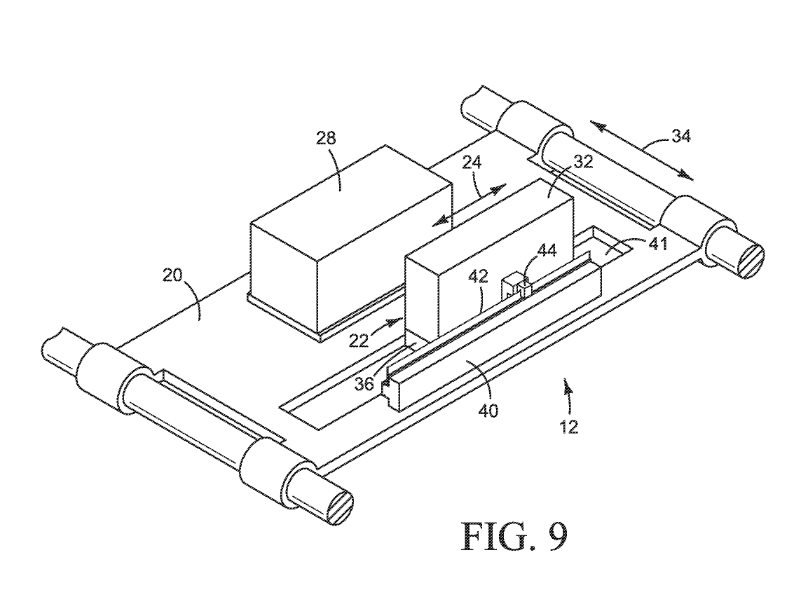

In the example shown in FIG. 9, a single fixed position printhead 28 is used with an adjustable position printhead 22. In this configuration, for example, adjustable position printhead 22 may be positioned upstream from a single fixed black or tri-color printhead 28 to dispense white ink, treatment solution or another liquid before printhead 28, aligned with printhead 28 to dispense the liquid with printhead 28, or downstream from printhead 28 to dispense the liquid after printhead 28.

In the examples shown, the line of substrate advance 24 and the carriage scan line 34 are perpendicular, which is typical of most inkjet printers. Accordingly, the position of the adjustable printhead(s) usually will be adjustable along the line of substrate advance (for both scanning carriage and stationary, page wide carriage printers). However, for printers in which the line of substrate advance and the carriage scan line are not perpendicular, or where it is otherwise desirable, the axis of adjustment may lie along a line perpendicular to the carriage scan line that is skewed with respect to the line of substrate advance. That is to say, the position of the adjustable printhead(s) is adjustable with respect to the line of substrate advance, but not necessarily along the line of substrate advance in all configurations.

As noted at the beginning of this Description, the examples shown in the figures and described above illustrate but do not limit the invention. Other examples are possible, including (but not limited to) using more or fewer fixed position printheads, using more or fewer adjustable position printheads, or changing the respective locations of the fixed and adjustable position printheads from that shown. Therefore, the foregoing description should not be construed to limit the scope of the invention, which is defined in the following claims.

What is claimed is:

1. A printhead assembly for dispensing liquid on to a substrate that moves along a line of substrate advance, the assembly comprising:
a first printhead to dispense a first liquid, the first printhead being in a first position that is not adjustable along the line of substrate advance; and
a second printhead to dispense a second liquid different from the first liquid, the second printhead being in a second position that is adjustable along the line of substrate advance.

2. The assembly of claim 1, wherein the second printhead is adjustable along a continuum along the line of substrate advance.

3. The assembly of claim 1, wherein the second printhead is adjustable automatically along the line of substrate advance.

4. The assembly of claim 1, wherein the second printhead is adjustable automatically along a continuum along the line of substrate advance.

5. The assembly of claim 1, wherein:
the first printhead comprises a printhead to dispense ink; and
the second printhead comprises a printhead to dispense a liquid for treating the substrate before the first printhead dispenses ink on to the substrate or a liquid for treating the substrate after the first printhead dispenses ink on to the substrate.

6. The assembly of claim 1, wherein:
the first printhead comprises a printhead to dispense ink other than white ink; and
the second printhead comprises a printhead to dispense white ink.

7. A carriage assembly for an inkjet printer, comprising:
a chassis;
multiple first printheads on the chassis to dispense ink on to a substrate that moves past the chassis along a line of substrate advance when the carriage is installed in a printer, each first printhead in a position on the chassis that is fixed with respect to the line of substrate advance; and
a second printhead on the chassis to dispense a liquid, the second printhead in a position on the chassis that is adjustable with respect to the line of substrate advance.

8. The carriage assembly of claim 7, wherein:
the position of each first printhead is fixed along the line of substrate advance; and
the position of the second printhead is adjustable along the line of substrate advance.

9. The carriage assembly of claim 7, wherein:
when the carriage is installed in a printer, the carriage is movable back and forth across the substrate along a scan line; and
the second printhead is in a position on the chassis that is adjustable along a line perpendicular to the scan line.

10. The carriage assembly of claim 7, wherein the second printhead is positioned outboard from the first printheads on one side of the chassis.

11. The carriage assembly of claim 7, wherein:
the second printhead comprises multiple second printheads each adjustable on the chassis along the line of substrate advance;
a second printhead is positioned outboard from the first printheads on a first part of the chassis; and
a second printhead is positioned outboard from the first printheads on an a second part of the chassis opposite the first part.

12. The carriage assembly of claim 7, further comprising a mechanism to adjust the position of the second printhead along a continuum along the line of advance.

13. The carriage assembly of claim 12, wherein the mechanism to adjust the position of the second printhead comprises:
a stationary guide extending along the chassis on the line of substrate advance;
a follower on the second printhead to follow the guide; and
a position indicator operatively coupled between the follower and the guide to indicate the position of the follower on the guide.

14. A printer, comprising:
a carriage assembly movable back and forth across a print substrate during printing; and
a substrate transport for advancing a print substrate past the carriage assembly along a line of substrate advance;
the carriage assembly including:
multiple first printheads to dispense ink on to a print substrate moving past the carriage, the position of each first printhead being fixed along the line of substrate advance; and
a second printhead to dispense a liquid on to a print substrate moving past the carriage, the position of the second printhead being adjustable along the line of substrate advance.

15. The printer of claim 14, wherein the carriage assembly also includes:
a stationary guide extending along the line of substrate advance;
a follower on the second printhead to follow the guide; and
a position indicator operatively coupled between the follower and the guide to indicate the position of the follower on the guide.
